(19) United States
(12) Patent Application Publication
(10) Pub. No.: US 2021/0342645 A1
(43) Pub. Date: Nov. 4, 2021

(54) COMBINING ENSEMBLE TECHNIQUES AND RE-DIMENSIONING DATA TO INCREASE MACHINE CLASSIFICATION ACCURACY

(71) Applicant: International Business Machines Corporation, Armonk, NY (US)

(72) Inventors: Gerhardt Jacobus Scriven, Frisco, TX (US); Kartik Narayanaswamy, Bengaluru (IN); Venkatesh Halappa, Bengaluru (IN); Naganarasimha Subraveshti Vijayanarasimha, Bengaluru (IN)

(21) Appl. No.: 16/865,693

(22) Filed: May 4, 2020

(51) Int. Cl. G06K 9/62; G06N 20/00

(52) U.S. Cl. CPC G06K 9/6259; G06N 20/00; G06K 9/6223; G06K 9/6215

(57) ABSTRACT

Classifying unlabeled input data is provided. Euclidean distance and cosine similarity are calculated between an unlabeled input data point to be classified and a class label centroid of each class within a set of training data. A confidence value is calculated for each class label centroid based on the Euclidean distance and the cosine similarity between the unlabeled input data point and the class label centroid of each class. A highest confidence value equals a best matching class label centroid to the unlabeled input data point. A class label centroid having the highest confidence value is selected. The computer classifies the unlabeled input data point using a class label corresponding to the class label centroid having the highest confidence value.

### BACKGROUND

### 1. Field

The disclosure relates generally to machine classification and more specifically to combining ensemble techniques and re-dimensioning training data and unlabeled input data to increase accuracy of machine classification.

### 2. Description of the Related Art

Classification is a process of categorizing a given set of data into classes. Classification can be performed on both structured or unstructured data. The process starts with predicting the class of given data points. Classification predictive modeling is the task of approximating the mapping function from input variables to output variables. The main goal is to identify which class data will fall into.

Classification is supervised machine learning. The most common classification problems are spam detection, sentiment analysis, ad targeting, risk assessment, medical diagnosis, image classification, speech recognition, facial recognition, handwriting recognition, document classification, and the like. Classification problems are frequently organized by whether a classification is a binary problem (i.e., either A or B) or a multiclass problem (i.e., multiple classes that can be predicted by using a single model).

For example, spam detection by email service providers can be identified as a binary classification problem since only 2 classes exist (i.e., spam and not spam). A classifier utilizes training data to understand how given input data relate to the class. In this example, spam emails and non-spam emails are used as the training data whose class membership is known. When the classifier is trained accurately, the classifier can be used to detect whether an unknown email is either spam or not spam.

Many classification algorithms currently exist, but it is almost impossible to conclude which algorithm is superior to another. Determining which algorithm is the best for a classification problem depends on the particular algorithm and the nature of the available dataset.

### SUMMARY

According to one illustrative embodiment, a computer-implemented method for classifying unlabeled input data is provided. A computer calculates Euclidean distance and cosine similarity between an unlabeled input data point to be classified and a class label centroid of each class within a set of training data. The computer calculates a confidence value for each class label centroid based on the Euclidean distance and the cosine similarity between the unlabeled input data point and the class label centroid of each class. A high confidence value equals a best matching class label centroid to the unlabeled input data point. The computer selects a class label centroid having the highest confidence value. The computer classifies the unlabeled input data point using a class label corresponding to the class label centroid having the highest confidence value. According to other illustrative embodiments, a computer system and computer program product for classifying unlabeled input data are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of an XY scatter chart in accordance with an illustrative embodiment;

FIG. 4 is a diagram illustrating an example of an XY scatter chart with class label centroids in accordance with an illustrative embodiment;

FIG. 5 is a diagram illustrating an example of an XY scatter chart with Euclidean distance in accordance with an illustrative embodiment;

FIG. 6 is a diagram illustrating an example of an XY scatter chart with cosine similarity in accordance with an illustrative embodiment;

FIG. 7 is a diagram illustrating an example of an XY scatter chart with same Euclidean distance and different cosine similarity in accordance with an illustrative embodiment;

FIG. 8 is a diagram illustrating an example of an XY scatter chart with same cosine similarity and different Euclidean distance in accordance with an illustrative embodiment;

FIG. 9 is a diagram illustrating an example of transforming a 2-dimensional classification problem into a 3-dimensional classification problem in accordance with an illustrative embodiment;

FIG. 10 is a diagram illustrating an example of data within data in accordance with an illustrative embodiment;

FIG. 11 is a diagram illustrating an example of adding artificial dimensions to training data in accordance with an illustrative embodiment;

FIG. 12 is a diagram illustrating an example of classifying unlabeled data using added artificial dimensions in accordance with an illustrative embodiment;

FIG. 13 is a diagram illustrating an example of transforming a classification problem to centroids, Euclidean distance, and cosine similarity after addition of artificial dimensions in accordance with an illustrative embodiment;

FIG. 14 is a flowchart illustrating a process for classifying unlabeled input data in accordance with an illustrative embodiment; and

FIG. 15 is a flowchart illustrating a process for generating artificial dimensions to spatially pull apart data to increase classification accuracy in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

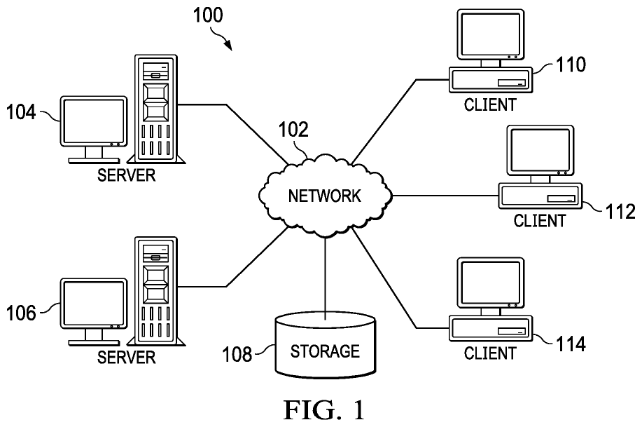

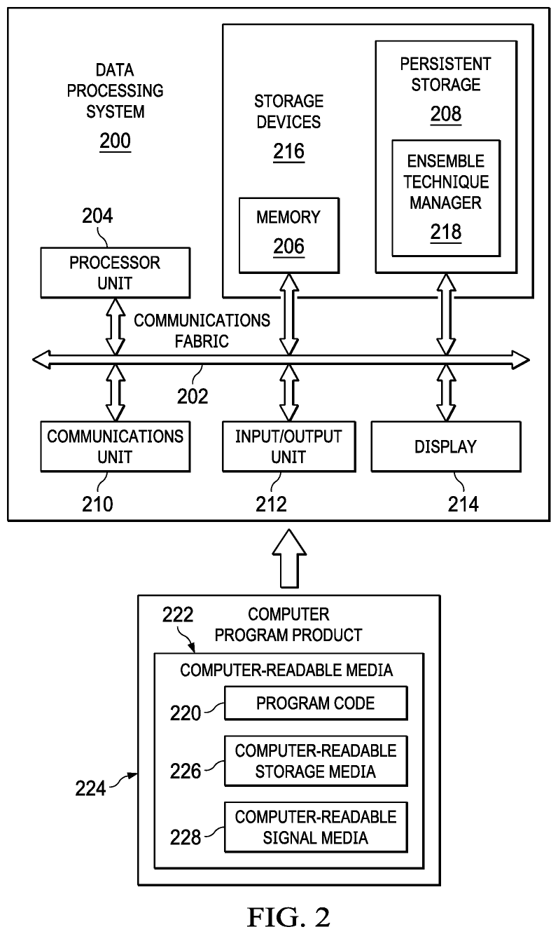

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. In addition, server 104 and server 106 provide data classification services to registered client devices by combining ensemble techniques and re-dimensioning training data and unlabeled input data to increase accuracy of the data classification. Also, it should be noted that server 104 and server 106 may each represent a cluster of servers in one or more data centers. Alternatively, server 104 and server 106 may each represent multiple computing nodes in one or more cloud environments.

Client 110, client 112, and client 114 also connect to network 102. Clients 110, 112, and 114 are registered clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart watches, smart televisions, smart vehicles, and the like, with wire or wireless communication links to network 102. Users of clients 110, 112, and 114 may utilize clients 110, 112, and 114 to access and utilize the data classification services provided by server 104 and server 106.

Storage 108 is a network storage device capable of storing any type of data in a structured format or an unstructured format. In addition, storage 108 may represent a plurality of network storage devices. Further, storage 108 may store identifiers and network addresses for a plurality of different client devices, identifiers for a plurality of different client device users, a plurality of different training datasets, classifiers, and the like. Furthermore, storage 108 may store other types of data, such as authentication or credential data that may include user names, passwords, and biometric data associated with system administrators and users, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), a telecommunications network, or any combination thereof. FIG. 1 is intended as an example only, and not as an architectural limitation for the different illustrative embodiments.

With reference now to FIG. 2, a diagram of a data processing system is depicted in accordance with an illustrative embodiment. Data processing system 200 is an example of a computer, such as server 104 in FIG. 1, in which computer readable program code or instructions implementing processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis or a persistent basis. Further, a computer readable storage device excludes a propagation medium. Memory 206, in these examples, may be, for example, a random-access memory (RAM), or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores ensemble technique manager 218. However, it should be noted that even though ensemble technique manager 218 is illustrated as residing in persistent storage 208, in an alternative illustrative embodiment ensemble technique manager 218 may be a separate component of data processing system 200. For example, ensemble technique manager 218 may be a hardware component coupled to communication fabric 202 or a combination of hardware and software components. In another alternative illustrative embodiment, a first set of components of ensemble technique manager 218 may be located in data processing system 200 and a second set of components of ensemble technique manager 218 may be located in a second data processing system, such as, for example, server 106 or client 110 in FIG. 1.

Ensemble technique manager 218 controls the process of combining multiple ensemble techniques and re-dimensioning training data and unlabeled input data to increase accuracy of machine data classification. Ensemble technique manager 218 utilizes supervised machine learning. Ensemble technique manager 218 first combines centroids together with Euclidean distance and cosine similarity. Ensemble technique manager 218 can apply this combination of ensemble techniques to continuous data, such as, for example, streaming stock market data, or to discreet data, such as, for example, text, as long as such the discreet data can be represented in a vector format.

Ensemble technique manager 218 calculates a centroid (i.e., vector) for each class. Ensemble technique manager 218 generates a “gravitational center” of all the vectors for each class label by calculating the average of all the training data vectors for that particular class label. Ensemble technique manager 218 then looks at the similarity of an unlabeled data point to each of the class label centroids. Ensemble technique manager 218 returns the class label corresponding to the class label centroid that best matches the unlabeled data point as the class label for that particular unlabeled data point.

The Euclidean distance is the straight-line distance between two vectors. The smaller the Euclidean distance between two vectors, the more the vectors are alike. Hence, by comparing an unlabeled data point to the centroids of each class label, it is logical that the centroid with the smallest Euclidean distance to the unlabeled data point represents the best matching class label. Cosine similarity is a measure of similarity between two non-zero vectors of an inner product space that measures cosine of the angle between the vectors. Cosine similarity represents a judgment of orientation and not of magnitude. In other words, two vectors with the same orientation have a cosine similarity of “1”, two vectors at 90° have a cosine similarity of “0”, and two vectors diametrically opposed have a cosine similarity of “−1”, which are independent of their magnitude. Ensemble technique manager 218 utilizes this novel combination of Euclidean distance and cosine similarity to measure the closest matching class label centroid to the unlabeled input data.

When centroids overlap or are partially overlapped, and for any given unlabeled data point the Euclidean distance and cosine similarity are the same or substantially the same, ensemble technique manager 218 then utilizes the k-nearest neighbor technique. In other words, ensemble technique manager 218 re-dimensions the unlabeled data points by generating additional artificial dimensions to the unlabeled data points using k-nearest neighbor information to pull the data apart so that ensemble technique manager 218 can generate new more meaningful centroids (i.e., separated centroids (e.g., not overlapping)). After pulling the data apart by adding artificial dimensions to the unlabeled data points using k-nearest neighbor information to generate the new centroids, ensemble technique manager 218 is now able to measure the closest matching class label centroid to the unlabeled input data using Euclidean distance and cosine similarity.

As a result, data processing system 200 operates as a special purpose computer system in which ensemble technique manager 218 in data processing system 200 enables the combination of multiple ensemble techniques and the re-dimensioning of training data and unlabeled input data to increase accuracy of machine data classification. In particular, ensemble technique manager 218 transforms data processing system 200 into a special purpose computer system as compared to currently available general computer systems that do not have ensemble technique manager 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 220 is located in a functional form on computer readable media 222 that is selectively removable and may be loaded onto or transferred to data processing system 200 for running by processor unit 204. Program code 220 and computer readable media 222 form computer program product 224. In one example, computer readable media 222 may be computer readable storage media 226 or computer readable signal media 228.

In these illustrative examples, computer readable storage media 226 is a physical or tangible storage device used to store program code 220 rather than a medium that propagates or transmits program code 220. Computer readable storage media 226 may include, for example, an optical or magnetic disc that is inserted or placed into a drive or other device that is part of persistent storage 208 for transfer onto a storage device, such as a hard drive, that is part of persistent storage 208. Computer readable storage media 226 also may take the form of a persistent storage, such as a hard drive, a thumb drive, or a flash memory that is connected to data processing system 200.

Alternatively, program code 220 may be transferred to data processing system 200 using computer readable signal media 228. Computer readable signal media 228 may be, for example, a propagated data signal containing program code 220. For example, computer readable signal media 228 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer readable media 222” can be singular or plural. For example, program code 220 can be located in computer readable media 222 in the form of a single storage device or system. In another example, program code 220 can be located in computer readable media 222 that is distributed in multiple data processing systems. In other words, some instructions in program code 220 can be located in one data processing system while other instructions in program code 220 can be located in one or more other data processing systems. For example, a portion of program code 220 can be located in computer readable media 222 in a server computer while another portion of program code 220 can be located in computer readable media 222 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 220.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

One goal in machine classification problems is finding techniques that are as accurate as possible, while at the same time using as little processing power as possible. Having higher accuracy is logically desirable for any classification domain. In addition, making the process as computationally efficient as possible is also desirable, especially when data classification is time sensitive. For example, when processing continuous data, such as stock market data or the like, in real time.

When applying different techniques for solving a classification problem, such as the well-known Iris species classification problem, a user may find that different techniques yield better accuracy than others, or that at times a given technique does not work well at all. Thus, a challenge to the user is to identify which technique is more appropriate for the given dataset. Moreover, some of the harder classification problems to solve are when a measure of overlap exists among training data and/or outlier data.

One way to solve the classification problem is to combine different techniques so that the combination provides a better classification result. This is known as ensemble techniques. Illustrative embodiments provide a novel ensemble technique that yields superior classification results.

Illustrative embodiments combine four vector-based techniques to determine which class label has the best match to the input data for supervised machine-driven classification problems. The four vector-based techniques include centroids, Euclidean distance, cosine similarity, and k-nearest neighbors. Centroids accuracy can depend on the class data distribution, and when the class data distribution is uneven, partially overlapping, or non-linear, the classification is less accurate. Thus, illustrative embodiments combine centroids with several other techniques. Further, by utilizing both Euclidean distance and cosine similarity, illustrative embodiments negate weaknesses in only employing Euclidean distance or only cosine similarity.

While current techniques try to improve classification accuracy by focusing on improving centroids calculations or using weights, illustrative embodiments focus on re-dimensioning data in the Euclidean space allowing for greater spatial separation of the centroids and, hence, the boundaries that divide the various classes. In doing this, illustrative embodiments spatially pull the centroids apart more distinctly. Furthermore, when illustrative embodiments apply this data re-dimensioning technique to unlabeled data, the classification becomes more accurate. Moreover, illustrative embodiments by using data re-dimensioning to pull the centroids apart has the benefit of dealing with outlier data.

Illustrative embodiments further increase the accuracy of classification (or circumvent scenarios where centroids will generally not work because the centroids are located close to each other, or, the dividing planes between class labels are not linear or clearly delineated) by generating additional artificial dimensions in training data or unlabeled input data. For n-dimensional data, generating additional artificial dimensions in the training data and unlabeled data using other known properties increases classification accuracy when illustrative embodiments combine this technique with centroids, Euclidean distance, and cosine similarity techniques. Illustrative embodiments generate the additional dimensions via analysis of k-nearest neighbors of each training data point or unlabeled input data point. Illustrative embodiments combine this technique of generating additional dimensions with the centroids, Euclidean distance, and cosine similarity techniques in a novel way that works for any training dataset or unlabeled input dataset.

Illustrative embodiments first calculate the centroids of the training dataset for each class label. Then, illustrative embodiments calculate both the Euclidean distance and cosine similarity between an unlabeled data input and the centroids for each class label. This combining of centroids, Euclidean distance, and cosine similarity techniques ensures that where one technique may struggle to distinguish between class labels the other techniques will assist. For each class label, illustrative embodiments express the confidence match level as the cosine similarity*(1/Euclidean distance). Illustrative embodiments utilize 1/Euclidean distance because a smaller Euclidean distance represents a greater class label match. Further, a smaller angle between an unlabeled data point and a class label's centroid implies a greater cosine similarity. Using the combination of centroids, Euclidean distance, and cosine similarity works best when the dividing plane or planes between class labels is or are linear in nature (e.g., when the centroids are clearly separable and data is generally evenly distributed (i.e., with few or no outliers)).

When the centroids are not clearly separable and the data is not evenly distributed, illustrative embodiments re-dimension the data by generating additional artificial dimensions to the training data using k-nearest neighbor information. Here, “k” is a configurable parameter and the number of additional dimensions to be added to training data points is equal the number of class labels of the classification problem. Illustrative embodiments also apply this same principle to unlabeled input data. Effects of adding additional dimensions are: a) data contained within other data, regardless of the number of dimensions or the shape of the data, are now more clearly distinguishable from one another and class label centroids that were completely or partially overlapped before the addition of additional dimensions no longer overlap; and b) the centroid concept that provides a generalized “gravitational pull” on data points is enriched with the knowledge of localized data behavior, which helps in classifying outlier data. As a result, illustrative embodiments increase classification accuracy of training data, as well as unlabeled input data, without requiring neural networks or deep learning techniques, which makes illustrative embodiments more computationally friendly as compared to neural networks or deep learning techniques. Furthermore, illustrative embodiments are capable of solving continuous data classification problems, but are not limited to classifying continuous data. For example, illustrative embodiments may also solve discrete data classification problems (e.g., classify textual data), as long as illustrative embodiments can represent the discrete data in a vector format.

Thus, illustrative embodiments provide one or more technical solutions that overcome a technical problem with increasing machine classification accuracy. As a result, these one or more technical solutions provide a technical effect and practical application in the field of machine classification.

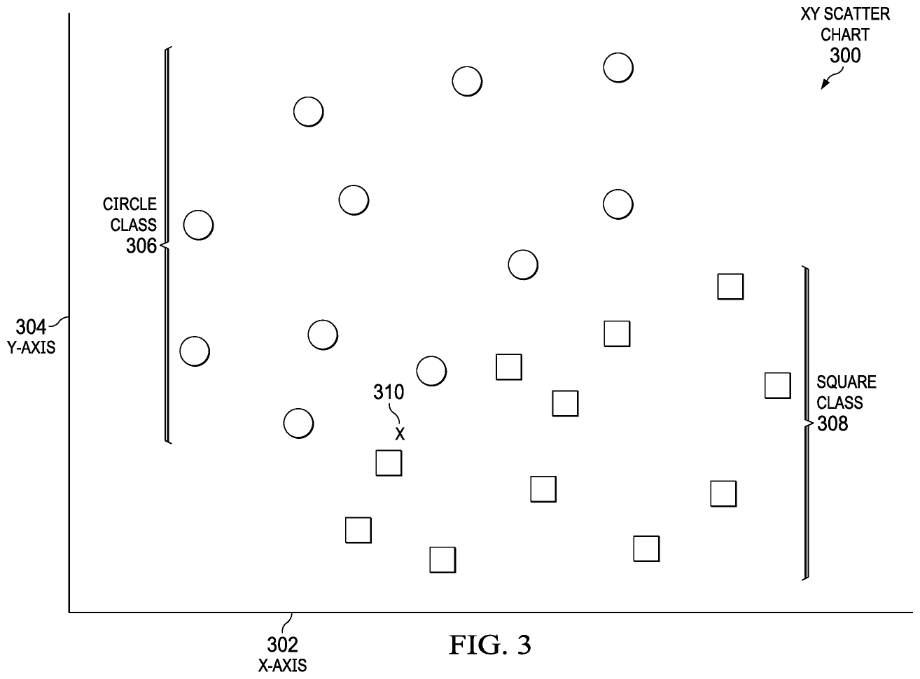

With reference now to FIG. 3, a diagram illustrating an example of an XY scatter chart is depicted in accordance with an illustrative embodiment. XY scatter chart 300 may be implemented in a computer, such as, for example, server 104 in FIG. 1 or data processing system 200 in FIG. 2. XY scatter chart 300 is a 2-dimensional space that uses Cartesian coordinates to display values corresponding to two properties of a set of data. XY scatter chart 300 displays the data as a collection of points, each having a value of one property determining the position on horizontal x-axis 302 and a value of another property determining the position on vertical y-axis 304.

In other words, illustrative embodiments can represent each of the two properties numerically for each training or unlabeled data point. As a result, illustrative embodiments can plot training and unlabeled data points on XY scatter chart 300, where each axis corresponds to one of the properties.

In this example, XY scatter chart 300 shows the distribution of data points belonging to two distinct classes, circle class 306 and square class 308. However, it should be noted that circle class 306 and square class 308 are meant as example data classes only and may represent any class or category of data. Further, it should be noted that illustrative embodiments are equally valid for n-dimensional data with any number of classes. The task is to classify unlabeled data point X 310.

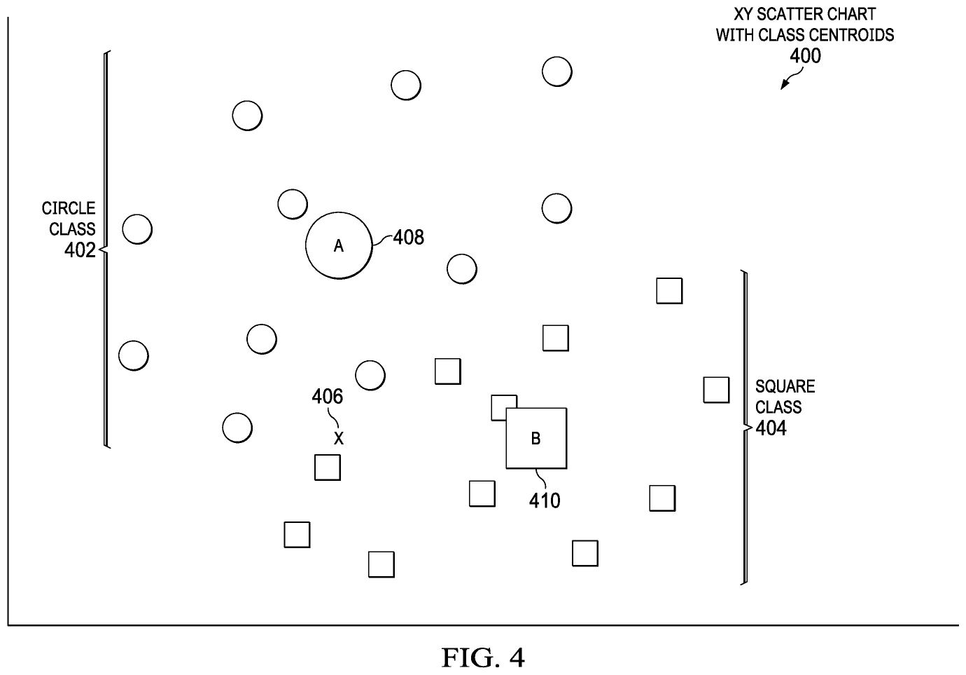

With reference now to FIG. 4, a diagram illustrating an example of an XY scatter chart with class label centroids is depicted in accordance with an illustrative embodiment. XY scatter chart with class label centroids 400 includes circle class 402, square class 404, and unlabeled data point X 406, such as, for example, circle class 306, square class 308, and unlabeled data point X 310 in XY scatter chart 300 of FIG. 3. It should be noted that the examples shown in FIGS. 4-9 includes XY scatter charts similar to XY scatter chart 300 of FIG. 3.

However, XY scatter chart with class label centroids 400 also includes circle class label centroid A 408 and square class label centroid B 410. Circle class label centroid A 408 and square class label centroid B 410 represent calculated centroids for circle class 402 and square class 404, respectively. Illustrative embodiments calculate each respective class label centroid by determining the average vector of the training data points for the corresponding class label.

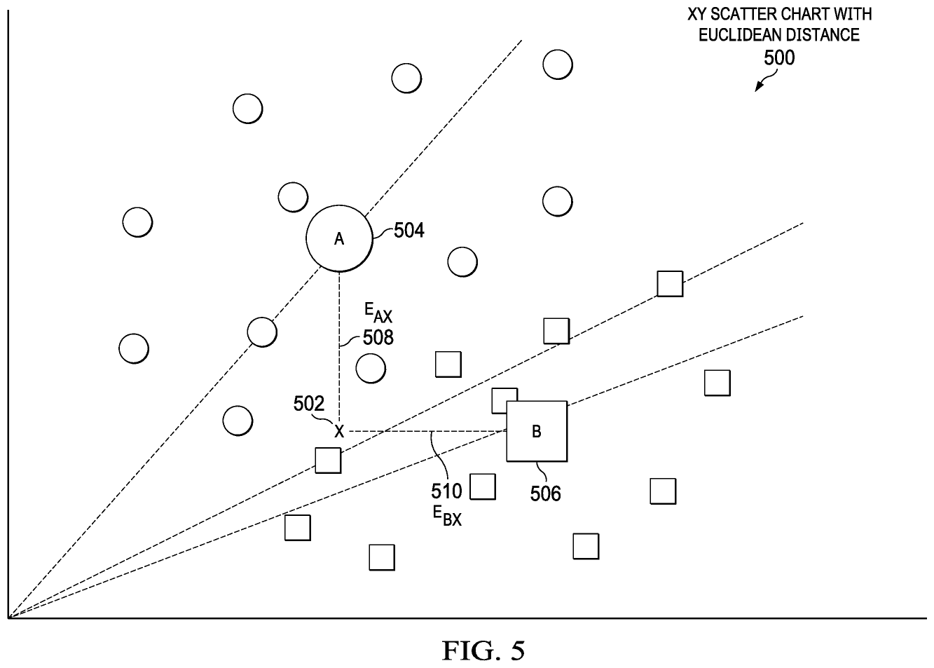

With reference now to FIG. 5, a diagram illustrating an example of an XY scatter chart with Euclidean distance is depicted in accordance with an illustrative embodiment. XY scatter chart with Euclidean distance 500 includes unlabeled data point X 502, circle class label centroid A 504, and square class label centroid B 506, such as, for example, unlabeled data point X 406, circle class label centroid A 408, and square class label centroid B 410 in XY scatter chart with class label centroids 400 of FIG. 4.

Illustrative embodiments classify unlabeled data point X 502 by comparing the closeness of unlabeled data point X 502 to each of circle class label centroid A 504 and square class label centroid B 506. To determine the closeness of unlabeled data point X 502 to circle class label centroid A 504 and square class label centroid B 506 in this example, illustrative embodiments employ Euclidean distance. However, it should be noted that a situation may arise where the Euclidean distance is the same or substantially the same between the unlabeled data point and the two class labels. As a result, the confidence at which the unlabeled data point can accurately be labeled decreases, which may result in misclassification. This situation is shown schematically in FIG. 5 where E_{AX} 508 (i.e., Euclidean distance between circle class label centroid A 504 and unlabeled data point X 502) and E_{BX} 510 (i.e., Euclidean distance between square class label centroid B 506 and unlabeled data point X 502) are equal or substantially equal, even though a human may visually classify unlabeled data point X 502 with a square class label as opposed to a circle class label.

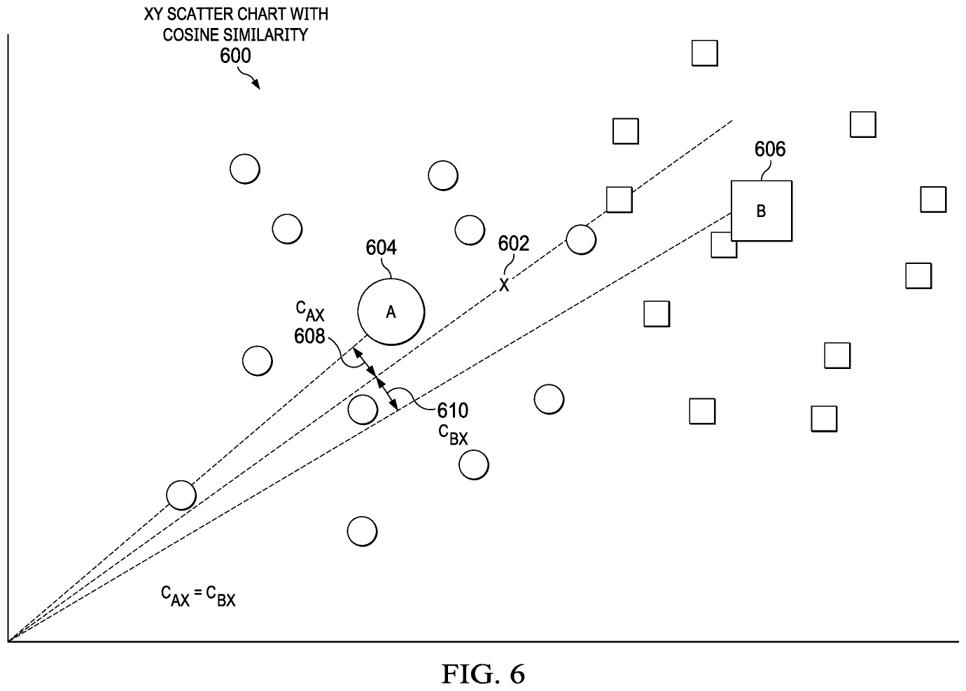

With reference now to FIG. 6, a diagram illustrating an example of an XY scatter chart with cosine similarity is depicted in accordance with an illustrative embodiment. XY scatter chart with cosine similarity 600 includes unlabeled data point X 602, circle class label centroid A 604, and square class label centroid B 606. To determine the closeness of unlabeled data point X 602 to circle class label centroid A 604 and square class label centroid B 606 in this example, illustrative embodiments employ cosine similarity. However, it should be noted that a situation may arise where the cosine similarity is the same or substantially the same between the unlabeled data point and the two class labels, which is similar to the Euclidean distance example in FIG. 5. As a result, the confidence at which the unlabeled data point can accurately be labeled decreases, which may result in misclassification. This situation is shown schematically in FIG. 6 where C_{AX} 608 (i.e., cosine similarity between circle class label centroid A 604 and unlabeled data point X 602) and C_{BX} 610 (i.e., cosine similarity between square class label centroid B 606 and unlabeled data point X 602) are equal or substantially equal, even though a human may visually classify unlabeled data point X 602 with a circle class label as opposed to a square class label in this example.

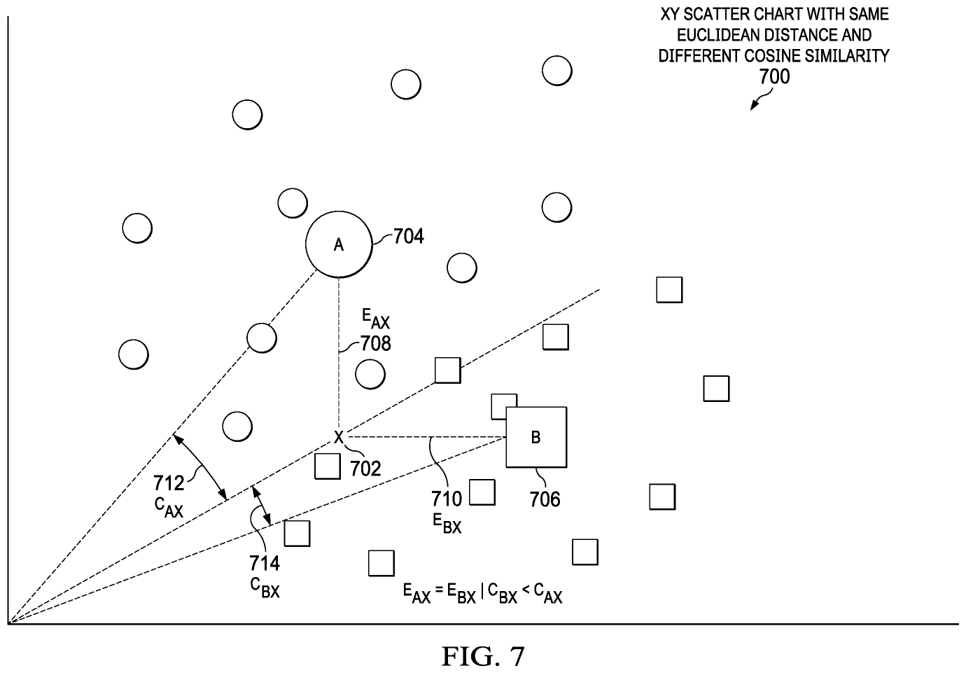

With reference now to FIG. 7, a diagram illustrating an example of an XY scatter chart with same Euclidean distance and different cosine similarity is depicted in accordance with an illustrative embodiment. XY scatter chart with same Euclidean distance and different cosine similarity 700 includes unlabeled data point X 702, circle class label centroid A 704, and square class label centroid B 706. To determine the closeness of unlabeled data point X 702 to circle class label centroid A 704 and square class label centroid B 706 in this example, illustrative embodiments employ a combination of Euclidean distance and cosine similarity techniques in such a way that the weaknesses of the Euclidean distance technique is offset by the strength of the cosine similarity technique to compute the class label that most closely matches unlabeled data point X 702.

For example, as in the example of FIG. 5 where E_{AX} 508 and E_{BX} 510 are equal or substantially equal, E_{AX} 708 and E_{BX} 710 are also equal or substantially equal, which decreases the confidence at which unlabeled data point X 702 can be labeled accurately. However, C_{AX} 712 and C_{BX} 714 are substantially different (i.e., not equal). In this example, C_{BX} 714 is smaller than C_{AX} 712. As a result, square class label centroid B 706 has a greater cosine similarity to unlabeled data point X 702, as compared to circle class label centroid A 704, which corresponds to an intuitive square label classification.

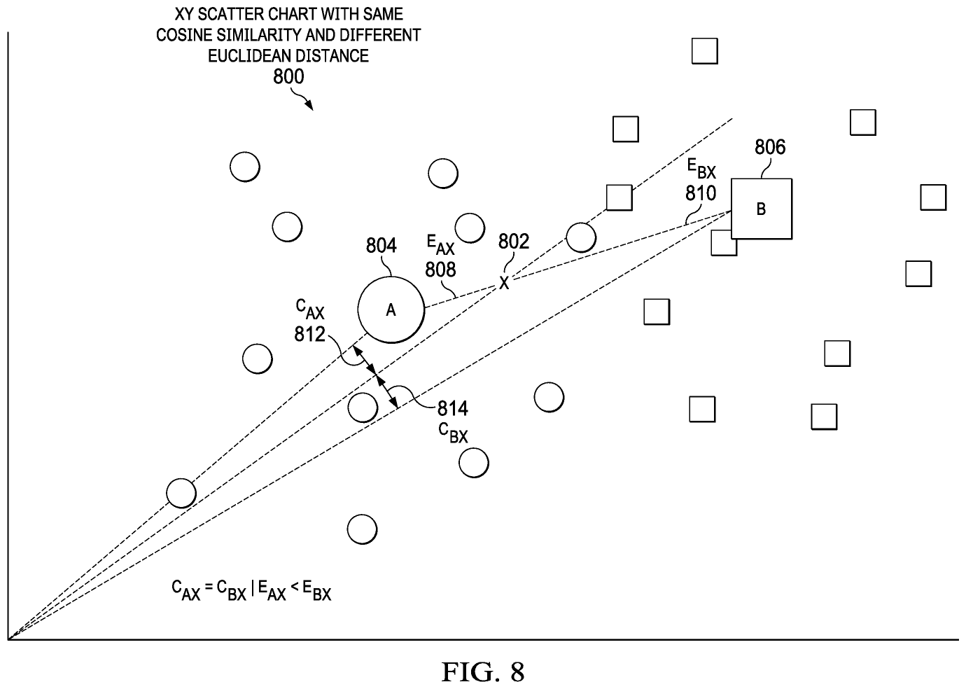

With reference now to FIG. 8, a diagram illustrating an example of an XY scatter chart with same cosine similarity and different Euclidean distance is depicted in accordance with an illustrative embodiment. XY scatter chart with same cosine similarity and different Euclidean distance 800 includes unlabeled data point X 802, circle class label centroid A 804, and square class label centroid B 806. To determine the closeness of unlabeled data point X 802 to circle class label centroid A 804 and square class label centroid B 806 in this example, illustrative embodiments employ a combination of Euclidean distance and cosine similarity techniques in such a way that the weaknesses of the cosine similarity technique is offset by the strength of the Euclidean distance technique to compute the class label that most closely matches unlabeled data point X 802.

For example, as in the example of FIG. 6 where C_{AX} 608 and C_{BX} 610 are equal or substantially equal, C_{AX} 812 and C_{BX} 814 are also equal or substantially equal, which decreases the confidence at which unlabeled data point X 802 can be labeled accurately. However, E_{AX} 808 and E_{BX} 810 are substantially different (i.e., not equal). In this example, E_{AX} 808 is smaller than E_{BX} 810. As a result, circle class label centroid A 804 has a greater correlation to unlabeled data point X 802, as compared to square class label centroid B 806, which corresponds to an intuitive circle label classification.

Illustrative embodiments mathematically express the Confidence_value as equal to CosineSimilarity_value*(1/EuclideanDistance_value), where the CosineSimilarity_value and EuclideanDistance_value take into consideration the class label centroids for each respective class label. Illustrative embodiments then rank the Confidence_values from highest to lowest, which produces an array of confidence values where the element zero (“0”) is the highest confidence value in the array, and it represents the class label with the best match to the unlabeled data point and, therefore, represents the best matching class that the unlabeled data point is projected to belong to.

Using this combination of centroid, Euclidean distance, and cosine similarity techniques is computationally friendly (i.e., uses less computational power than neural networks or deep learning techniques). However, as with any technique that uses centroids, classification accuracy can be sensitive to the distribution of the training data.

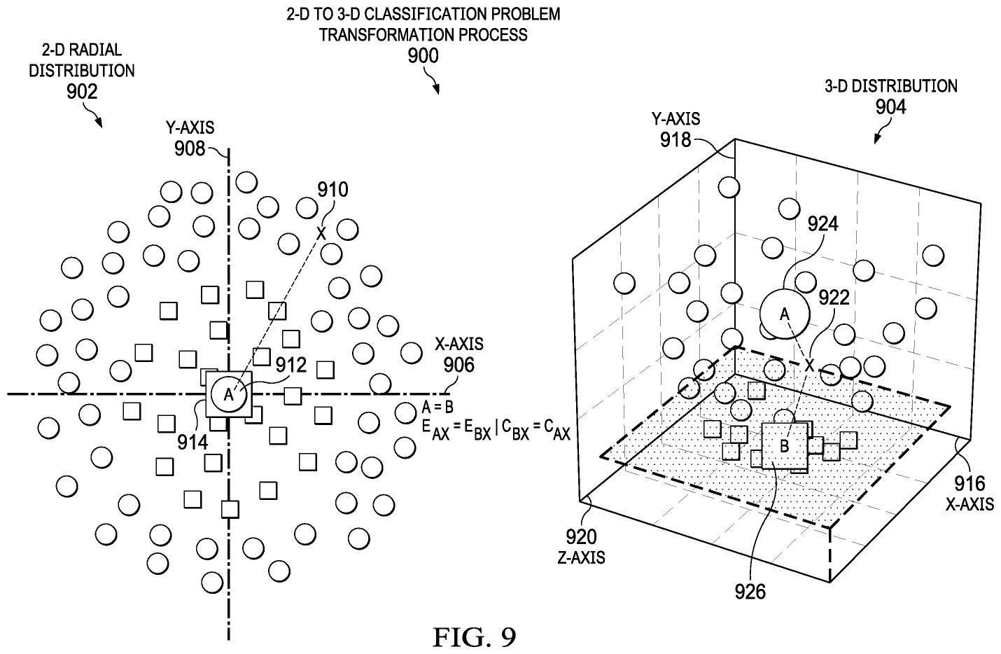

With reference now to FIG. 9, a diagram illustrating an example of transforming a 2-dimensional (2-D) classification problem into a 3-dimensional (3-D) classification problem is depicted in accordance with an illustrative embodiment. Illustrative embodiments can increase classification accuracy by changing an n-dimensional classification problem, where n denotes the number of parameters used to describe the data points (i.e., the vector dimension number), to a n+k dimensional classification problem where k represents the number of class labels, and the values associated with these additional vector subarrays are derived from k-nearest neighbor data.

In this example, 2-D to 3-D classification problem transformation process 900 includes 2-D radial distribution 902 and 3-D distribution 904. 2-D radial distribution 902 includes x-axis 906 and y-axis 908. In addition, 2-D radial distribution 902 also includes unlabeled data point X 910, circle class label centroid A 912, and square class label centroid B 914. 3-D distribution 904 includes x-axis 916, y-axis 918, and z-axis 920. Further, 3-D distribution 904 also includes unlabeled data point X 922, circle class label centroid A 924, and square class label centroid B 926. It should be noted that unlabeled data point X 922, circle class label centroid A 924, and square class label centroid B 926 are the same as unlabeled data point X 910, circle class label centroid A 912, and square class label centroid B 914, but shown on a 3-D distribution where the data points are spatially separated by addition of artificial dimensions as opposed to a 2-D radial distribution.

The classification problem shown in 2-D radial distribution 902 is a 2-dimensional problem with two class labels (i.e., circle class label centroid A 912 and square class label centroid B 914). It should be noted that this example is used to show how the logic of illustrative embodiments works in an easy-to-interpret manner. However, illustrative embodiments may apply this same logic on more complex classification problems.

In this example, the square class is completely enclosed by the circle class. In addition, circle class label centroid A 912 and square class label centroid B 914 are both located at the [0, 0] coordinates of 2-D radial distribution 902 (i.e., circle class label centroid A 912 and square class label centroid B 914 overlap). Consequently, using the combination of centroids, Euclidean distance, and cosine similarity, for any given unlabeled data point X on 2-D radial distribution 902, will result in both the Euclidean distance and the cosine similarity being the same or substantially the same, which decreases classification accuracy, even though a human may visually discern that unlabeled data point X 910 belongs to the circle class label.

2-D to 3-D classification problem transformation process 900 systematically pulls the data spatially apart so that 2-D to 3-D classification problem transformation process 900 can calculate meaningful class label centroids for each respective class. This spatial separation of the data points is shown in 3-D distribution 904. 2-D to 3-D classification problem transformation process 900 performs this spatial separation of the data points by adding an artificial dimension that calculates the dot product between each training data point and itself and, thus, in the process generates a third z-axis (i.e., z-axis 920). Logically, the dot product (i.e., z-axis value) will be smaller for training data points closer to the original [0, 0] coordinates of circle class label centroid A 912 and square class label centroid B 914 and larger for training data points further removed from the original [0, 0] coordinates.

2-D to 3-D classification problem transformation process 900 calculates the z-axis value for each respective training data point, adds the calculated z-axis value to the original x-axis value/y-axis value set for each respective training data point, and plots the results in 3-D distribution 904. The effect of adding the z-axis values creates a training dataset, that when 2-D to 3-D classification problem transformation process 900 calculates the class label centroids, results in the class label centroids (i.e., circle class label centroid A 924, and square class label centroid B 926) no longer being overlapped. Now, illustrative embodiments can utilize the combination of centroids, Euclidean distance, and cosine similarity to determine the classification of unlabeled data point X 922, as long as illustrative embodiments apply the same process to unlabeled data point X 922 (i.e., calculate a z-axis value by creating a dot product between unlabeled data point X 922 and itself).

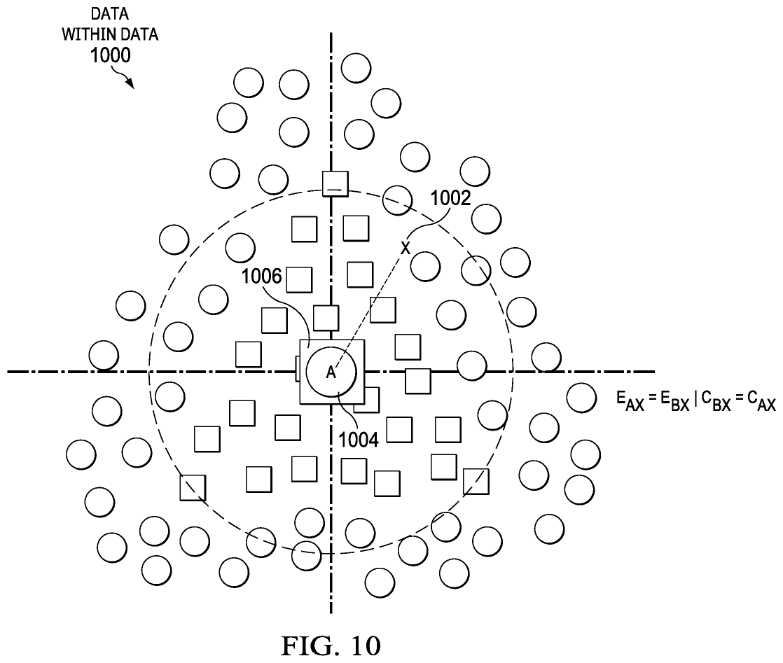

With reference now to FIG. 10, a diagram illustrating an example of data within data is depicted in accordance with an illustrative embodiment. Data within data 1000 is similar to the data distribution in 2-D radial distribution 902 in FIG. 9. Similarly, data within data 1000 includes unlabeled data point X 1002, circle class label centroid A 1004, and square class label centroid B 1006, such as unlabeled data point X 910, circle class label centroid A 912, and square class label centroid B 914 in FIG. 9.

However, while existing solutions, such as, for example, kernel methods, may be effective in the data distribution example in FIG. 9, existing solutions will fail to produce accurate classification results in the data distribution example depicted in FIG. 10. In the example of FIG. 10, similar to the example in FIG. 9, the circle class of training data points encapsulate the square class of training data points. However, now in the example of FIG. 10 the shape of the circle class is triangular. Using existing solutions will result in data misclassification of unlabeled data points, such as unlabeled data point X 1002. In other words, existing solutions do not successfully deal with outlier data points.

In contrast, illustrative embodiments work for both examples shown in FIG. 9 and FIG. 10, are effective for any dimensional problem with any number of class labels, and provide a process to deal with outlier data point. While existing solutions may add one dimension to the dataset shown in the example of FIG. 9, illustrative embodiments add an additional dimension for each class label in the classification problem.

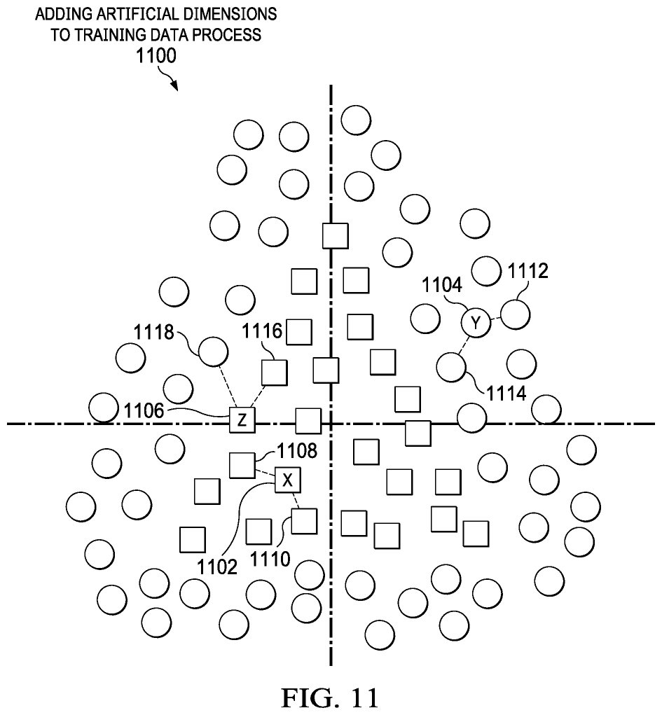

With reference now to FIG. 11, a diagram illustrating an example of adding artificial dimensions to training data is depicted in accordance with an illustrative embodiment. Adding artificial dimensions to training data process 1100 utilizes a similar data distribution as in the example of FIG. 10. In this example, adding artificial dimensions to training data process 1100 includes training data point X 1102, training data point Y 1104, and training data point Z 1106.

Illustrative embodiments describe each training data point as [Xa, Xb]. Illustrative embodiments increase the data point vector by an additional 2 dimensions, one representing the circle class label and the other representing the square class label. Illustrative embodiments set each new dimension value to k, where k relates to the number of nearest neighbors to be considered and is logically configurable. As a result, training data point [Xa, Xb] becomes [Xa, Xb, k, k]. In this example, k is set to 3. Thus, training data point [Xa, Xb] becomes [Xa, Xb, 3, 3].

It should be noted that the positions of the additional dimensions are fixed for the class label that they represent. In this example, illustrative embodiments set the circle class label to be the associated with the first additional dimension and the square class label to be associated with the second additional dimension. Illustrative embodiments then consider the k number of nearest neighbors for each training data point. For each nearest neighbor considered, illustrative embodiments subtract a value of 1 for the corresponding neighbor's class label. For example, if a nearest neighbor has a circle class label, then [Xa, Xb, 3, 3] becomes [Xa, Xb, 3-1, 3], which equals [Xa, Xb, 2, 3]. Similarly, if a nearest neighbor has a square class label, then [Xa, Xb, 3, 3] becomes [Xa, Xb, 3, 3-1], which equals [Xa, Xb, 3, 2].

It should be noted that each training data point is its own nearest neighbor. Consequently, the example of FIG. 11 shows only 2 lines reaching out from each training data point. The third line is effectively to that training data point, itself.

The net-net is that if the current training data point is of a square class label and all of its k-nearest neighbors are of the square class label too, then training data point [Xa, Xb] becomes [Xa, Xb, 3, 0]. This is training data point X 1102 with k-nearest neighbors 1108 and 1110, which all have the square class label. If the current training data point is of the circle class label and all of its k-nearest neighbors are of the circle class label too, then training data point [Ya, Yb] becomes [Ya, Yb, 0, 3]. This is training point Y 1104 with k-nearest neighbors 1112 and 1114, which all have the circle class label.

In this way, illustrative embodiments spatially pull apart the two classes from each other. However, closer to the boundaries between the two classes the delineation will be less distinct. For example, consider training data point Z 1106. Two nearest neighbors are of the square class label, which includes training data point Z 1106, itself, and nearest neighbor 1116, and one is of the circle class label (i.e., nearest neighbor 1118). Thus, the artificial dimension is [3-1, 3-2], which equals [2, 1]. As a result, illustrative embodiments re-dimension training data point Z 1106 from [Za, Zb] to [Za, Zb, 2, 1].

After the training data points are re-dimensioned, illustrative embodiments can now generate new centroids. In the example of FIG. 11, it is clear that the square class label's centroid will be [CRa, CRb, ˜3, ˜0], while the circle class label's centroid will be [CBa, CBb, ˜0, ˜3]. When using these centroids to classify an unlabeled data point, illustrative embodiments also need to re-dimension the unlabeled data point. Illustrative embodiments utilize a process similar to the process for re-dimensioning the training data points, but also takes into account another factor, which is proximity of the unlabeled data point to each of the k-nearest neighbors when re-dimensioning the unlabeled data point.

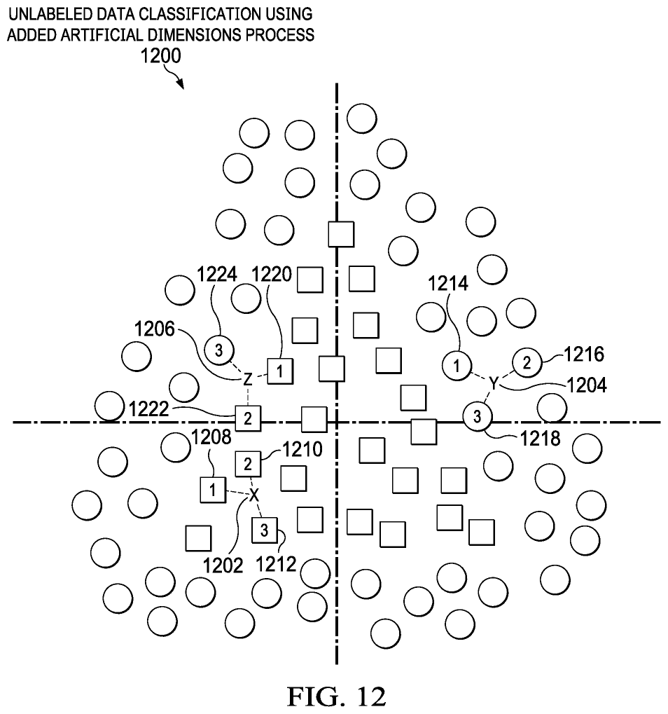

With reference now to FIG. 12, a diagram illustrating an example of classifying unlabeled data using added artificial dimensions is depicted in accordance with an illustrative embodiment. In this example, unlabeled data classification using added artificial dimensions process 1200 includes unlabeled data point X 1202, unlabeled data point Y 1204, and unlabeled data point Z 1206.

For unlabeled data point X 1202, all 3 k-nearest neighbors (i.e., nearest neighbor 1 1208, nearest neighbor 2 1210, and nearest neighbor 3 1212) are of the square class label and, therefore, the artificial dimension is [3, 3-3], which equals [3, 0]. As a result, illustrative embodiments re-dimension unlabeled data point X 1202 from [Xa, Xb] to [Xa, Xb, 3, 0]. When illustrative embodiments now classify unlabeled data point X 1202, these additional dimensions ensure that the Euclidean distance and cosine similarity converge to a square label classification.

For unlabeled data point Y 1204, all 3 k-nearest neighbors (i.e., nearest neighbor 1 1214, nearest neighbor 2 1216, and nearest neighbor 3 1218) are of the circle class label and, therefore, the artificial dimension is [3-3, 3], which equals [0, 3]. As a result, illustrative embodiments re-dimension unlabeled data point Y 1204 from [Ya, Yb] to [Ya, Yb, 0, 3]. When illustrative embodiments now classify unlabeled data point Y 1204, these additional dimensions ensure that the Euclidean distance and cosine similarity converge to a circle label classification.

For unlabeled data point Z 1206, when a mixture of class labels exists across the k-nearest neighbors (i.e., nearest neighbor 1 1220 and nearest neighbor 2 1222 are of the square class label and nearest neighbor 3 1224 is of the circle class label), illustrative embodiments take into account the inverse of the distance squared to each of the k-nearest neighbors. The squared distance is considered through inspiration of gravitational physics, as well as wave radiation, where strength or intensity decreases by the square of the distance. For example, assume the Euclidean distance between unlabeled data point Z 1206 and nearest neighbor 1 1220 is equal to 1, the Euclidean distance between unlabeled data point Z 1206 and nearest neighbor 2 1222 is equal to 1.5, and the Euclidean distance between unlabeled data point Z 1206 and nearest neighbor 3 1224 is equal to 2.

As a result: nearest neighbor 1 1220, which has a square class label, carries a radial weight of (1/1)²; nearest neighbor 2 1222, which also has a square class label, carries a radial weight of (1/1.5)²; and nearest neighbor 3 1224, which has a circle class label, carries a radial weight of (1/2)². These k-nearest neighbors are now proportionally distributed as a function of the total and normalized to k, which is equal to 3. The total is equal to (1+4/9+1/4)=61/36. Hence, nearest neighbor 1 1220 is associated with (36/36)/(61/36)=0.59. Nearest neighbor 2 1222 is associated with (16/36)/(61/36)=0.26. Nearest neighbor 3 1224 is associated with (9/35)/(61/36)=0.15. Normalizing this across k=3, yields values of 1.77 (circle label), 0.78 (circle label), and 0.45 (square label) for nearest neighbor 1 1220, nearest neighbor 2 1222, and nearest neighbor 3 1224, respectively. As a result, the artificial dimension is [3−0.45, 3−(1.77+0.78)], which is equal to [2.55, 0.45]. As a result, illustrative embodiments re-dimension unlabeled data point Z 1206 from [Za, Zb] to [Za, Zb, 2.55, 0.45]. When illustrative embodiments now classify unlabeled data point Z 1206, these extra dimensions ensure that the Euclidean distance and cosine similarity converge to a square label classification. It should be noted that the square class label centroid's extra dimensions will be [˜3, ˜0], whereas the circle class label centroid's extra dimensions will be [˜0, ˜3].

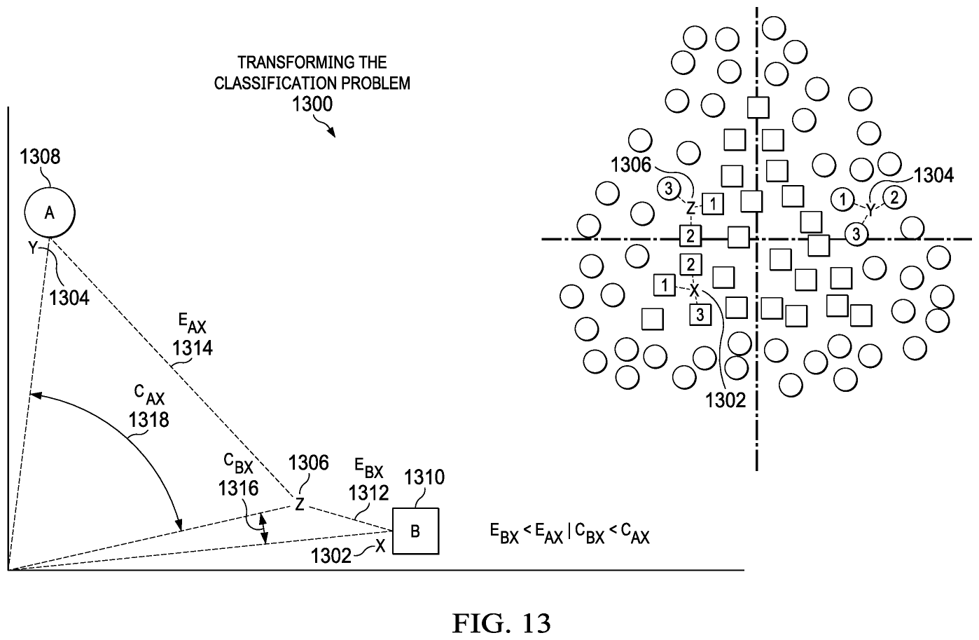

With reference now to FIG. 13, a diagram illustrating an example of transforming a classification problem to centroids, Euclidean distance, and cosine similarity after addition of artificial dimensions is depicted in accordance with an illustrative embodiment. Transforming the classification problem 1300 uses the data distribution example of FIG. 12 (shown on the right side of the diagram) and includes unlabeled data point X 1302, unlabeled data point Y 1304, and unlabeled data point Z 1306, such as unlabeled data point X 1202, unlabeled data point Y 1204, and unlabeled data point Z 1206 in FIG. 12.

In this example, assume that the original centroids overlapped. Now, the centroids are a function of the new artificial dimension values. By ignoring the original data points, illustrative embodiments can now place the re-dimensioned data, for both class label centroids and unlabeled data points, in a 2-dimensional space (shown on the left side of the diagram). In doing so, illustrative embodiments can now apply Euclidean distance and cosine similarity on the re-dimensioned data to yield an accurate result. For example, the 2-dimensional space includes unlabeled data point X 1302, unlabeled data point Y 1304, unlabeled data point Z 1306, circle class label centroid A 1308, and square class label centroid B 1310. In this example, E_{BX} 1312 is less than E_{AX} 1314 and C_{BX} 1316 is less than C_{AX} 1318.

It should be noted that discarding the original dimensions only makes sense in the situation where the original centroids overlap. If the original centroids do not overlap, then illustrative embodiments use all n+k dimensions to perform the classification. As discussed above, re-dimensioning data points also helps in situations where outlier data points exist, which is a known weakness of pure centroid models.

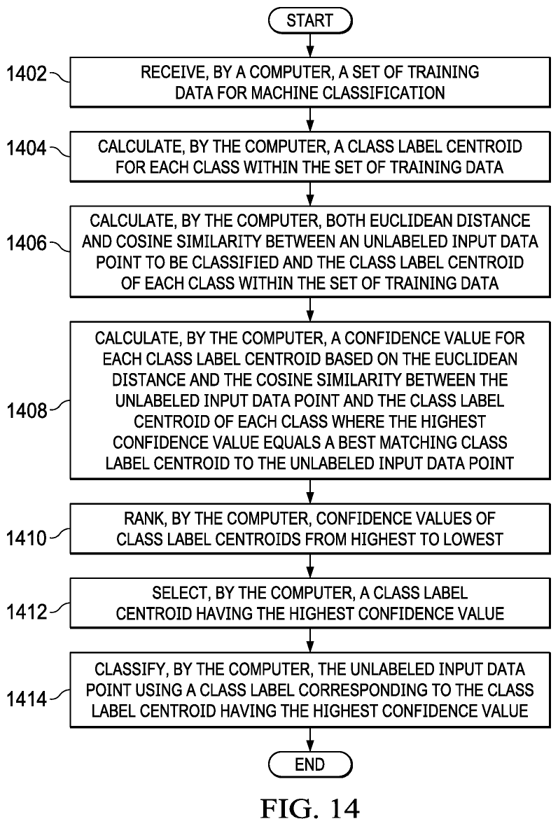

With reference now to FIG. 14, a flowchart illustrating a process for classifying unlabeled input data is shown in accordance with an illustrative embodiment. The process shown in FIG. 14 may be implemented in a computer, such as, for example, server 104 in FIG. 1 or data processing system 200 in FIG. 2.

The process begins when the computer receives a set of training data for machine classification (step 1402). The computer calculates a class label centroid for each class within the set of training data (step 1404). Then, the computer calculates both Euclidean distance and cosine similarity between an unlabeled input data point to be classified and the class label centroid of each class within the set of training data (step 1406). The computer also calculates a confidence value for each class label centroid based on the Euclidean distance and the cosine similarity between the unlabeled input data point and the class label centroid of each class where the highest confidence value equals a best matching class label centroid to the unlabeled input data point (step 1408).

The computer ranks confidence values of class label centroids from highest to lowest (step 1410). The computer selects a class label centroid having the highest confidence value (step 1412). Afterward, the computer classifies the unlabeled input data point using a class label corresponding to the class label centroid having the highest confidence value (step 1414). Thereafter, the process terminates.

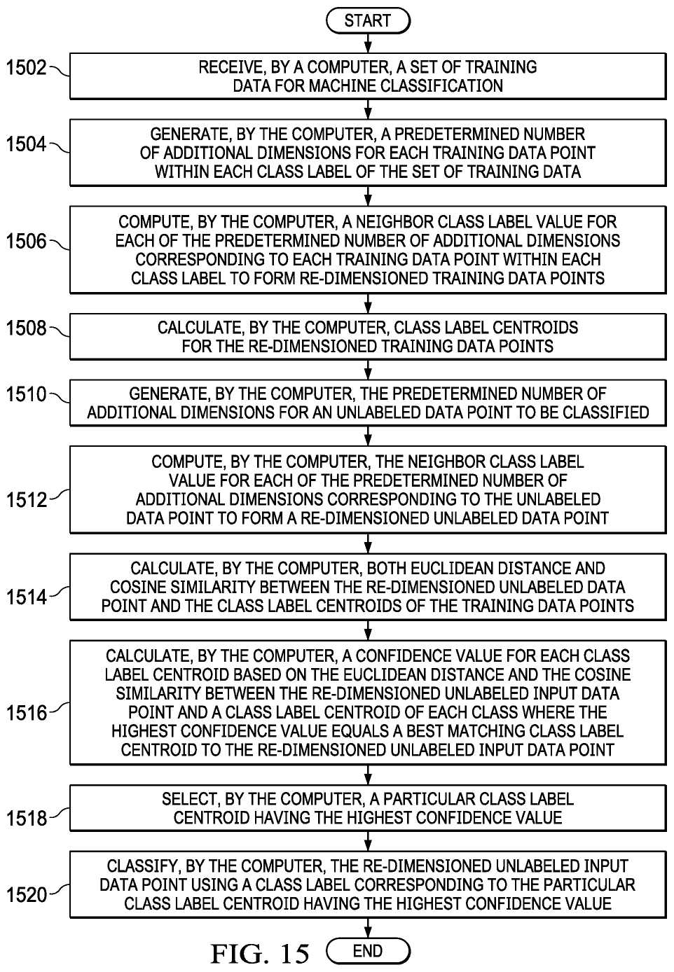

With reference now to FIG. 15, a flowchart illustrating a process for generating artificial dimensions to spatially pull apart data to increase classification accuracy is shown in accordance with an illustrative embodiment. The process shown in FIG. 15 may be implemented in a computer, such as, for example, server 104 in FIG. 1 or data processing system 200 in FIG. 2.

The process begins when the computer receives a set of training data for machine classification (step 1502). The computer generates a predetermined number of additional dimensions for each training data point within each class label of the set of training data (step 1504). The computer computes a neighbor class label value for each of the predetermined number of additional dimensions corresponding to each training data point within each class label to form re-dimensioned training data points (step 1506).

The computer calculates class label centroids for the re-dimensioned training data points (step 1508). The computer also generates the predetermined number of additional dimensions for an unlabeled data point to be classified (step 1510). In addition, the computer computes the neighbor class label value for each of the predetermined number of additional dimensions corresponding to the unlabeled data point to form a re-dimensioned unlabeled data point (step 1512).

Then, the computer calculates both Euclidean distance and cosine similarity between the re-dimensioned unlabeled data point and the class label centroids of the re-dimensioned training data points (step 1514). The computer further calculates a confidence value for each class label centroid based on the Euclidean distance and the cosine similarity between the re-dimensioned unlabeled input data point and a class label centroid of each class where the highest confidence value equals a best matching class label centroid to the re-dimensioned unlabeled input data point (step 1516).

The computer selects a particular class label centroid having the highest confidence value (step 1518). The computer classifies the re-dimensioned unlabeled input data point using a class label corresponding to the particular class label centroid having the highest confidence value (step 1520). Thereafter, the process terminates.

Thus, illustrative embodiments of the present invention provide a computer-implemented method, computer system, and computer program product for combining ensemble techniques and re-dimensioning training data and unlabeled input data to increase accuracy of machine classification. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for classifying unlabeled input data, the computer-implemented method comprising:
calculating, by a computer, Euclidean distance and cosine similarity between an unlabeled input data point to be classified and a class label centroid of each class within a set of training data;
calculating, by the computer, a confidence value for each class label centroid based on the Euclidean distance and the cosine similarity between the unlabeled input data point and the class label centroid of each class, wherein a highest confidence value equals a best matching class label centroid to the unlabeled input data point;
selecting, by the computer, a class label centroid having the highest confidence value; and
classifying, by the computer, the unlabeled input data point using a class label corresponding to the class label centroid having the highest confidence value.

2. The computer-implemented method of claim 1 further comprising:
generating, by the computer, a predetermined number of additional dimensions for each training data point within each class label of the set of training data;
computing, by the computer, a neighbor class label value for each of the predetermined number of additional dimensions corresponding to each training data point within each class label to form re-dimensioned training data points; and
calculating, by the computer, class label centroids for the re-dimensioned training data points.

3. The computer-implemented method of claim 2 further comprising:
generating, by the computer, the predetermined number of additional dimensions for an unlabeled data point to be classified;
computing, by the computer, the neighbor class label value for each of the predetermined number of additional dimensions corresponding to the unlabeled data point to form a re-dimensioned unlabeled data point; and
calculating, by the computer, Euclidean distance and cosine similarity between the re-dimensioned unlabeled data point and the class label centroids of the re-dimensioned training data points.

4. The computer-implemented method of claim 3, wherein the computer re-dimensions data points by generating additional artificial dimensions to the data points using k-nearest neighbor data, wherein k number of nearest neighbors is a configurable number and the additional artificial dimensions to be added to the data points is equal a number of class labels in a classification problem.

5. The computer-implemented method of claim 4, wherein the computer takes into account proximity of the unlabeled data point to each of the k number of nearest neighbors when re-dimensioning the unlabeled data point.

6. The computer-implemented method of claim 4, wherein the computer considers the k number of nearest neighbors for each training data point and subtracts a value of 1 from the k number for a corresponding nearest neighbor's class label, and wherein each training data point is its own nearest neighbor in the k number of nearest neighbors.

7. The computer-implemented method of claim 4, wherein the computer takes into account an inverse of a distance squared to each of the k number of nearest neighbors when a mixture of class labels exists across the k number of nearest neighbors.

8. The computer-implemented method of claim 4, wherein positions of the additional artificial dimensions are fixed for a class label such that each class label is associated with an additional dimension.

9. The computer-implemented method of claim 4, wherein the data points are one of continuous data points or discrete data points.

10. The computer-implemented method of claim 1, wherein the computer calculates a respective class label centroid by determining an average vector of training data points for a corresponding class label.

11. A computer system for classifying unlabeled input data, the computer system comprising:
a bus system;
a storage device connected to the bus system, wherein the storage device stores program instructions; and
a processor connected to the bus system, wherein the processor executes the program instructions to:
calculate Euclidean distance and cosine similarity between an unlabeled input data point to be classified and a class label centroid of each class within a set of training data;
calculate a confidence value for each class label centroid based on the Euclidean distance and the cosine similarity between the unlabeled input data point and the class label centroid of each class, wherein a highest confidence value equals a best matching class label centroid to the unlabeled input data point;
select a class label centroid having the highest confidence value; and
classify the unlabeled input data point using a class label corresponding to the class label centroid having the highest confidence value.

12. The computer system of claim 11, wherein the processor further executes the program instructions to:
generate a predetermined number of additional dimensions for each training data point within each class label of the set of training data;
compute a neighbor class label value for each of the predetermined number of additional dimensions corresponding to each training data point within each class label to form re-dimensioned training data points; and
calculate class label centroids for the re-dimensioned training data points.

13. The computer system of claim 12, wherein the processor further executes the program instructions to:
generate the predetermined number of additional dimensions for an unlabeled data point to be classified;
compute the neighbor class label value for each of the predetermined number of additional dimensions corresponding to the unlabeled data point to form a re-dimensioned unlabeled data point; and
calculate Euclidean distance and cosine similarity between the re-dimensioned unlabeled data point and the class label centroids of the re-dimensioned training data points.

14. The computer system of claim 13, wherein data points are re-dimensioned by generating additional artificial dimensions to the data points using k-nearest neighbor data, wherein k number of nearest neighbors is a configurable number and the additional artificial dimensions to be added to the data points is equal a number of class labels in a classification problem.

15. The computer system of claim 14, wherein proximity of the unlabeled data point to each of the k number of nearest neighbors is taken into account when re-dimensioning the unlabeled data point.

16. A computer program product for classifying unlabeled input data, the computer program product comprising a computer readable storage medium having program instructions embodied therewith, the program instructions executable by a computer to cause the computer to perform a method comprising:
calculating, by the computer, Euclidean distance and cosine similarity between an unlabeled input data point to be classified and a class label centroid of each class within a set of training data;
calculating, by the computer, a confidence value for each class label centroid based on the Euclidean distance and the cosine similarity between the unlabeled input data point and the class label centroid of each class, wherein a highest confidence value equals a best matching class label centroid to the unlabeled input data point;
selecting, by the computer, a class label centroid having the highest confidence value; and
classifying, by the computer, the unlabeled input data point using a class label corresponding to the class label centroid having the highest confidence value.

17. The computer program product of claim 16 further comprising:
generating, by the computer, a predetermined number of additional dimensions for each training data point within each class label of the set of training data;
computing, by the computer, a neighbor class label value for each of the predetermined number of additional dimensions corresponding to each training data point within each class label to form re-dimensioned training data points; and
calculating, by the computer, class label centroids for the re-dimensioned training data points.

18. The computer program product of claim 17 further comprising:
generating, by the computer, the predetermined number of additional dimensions for an unlabeled data point to be classified;
computing, by the computer, the neighbor class label value for each of the predetermined number of additional dimensions corresponding to the unlabeled data point to form a re-dimensioned unlabeled data point; and
calculating, by the computer, Euclidean distance and cosine similarity between the re-dimensioned unlabeled data point and the class label centroids of the re-dimensioned training data points.

19. The computer program product of claim 18, wherein the computer re-dimensions data points by generating additional artificial dimensions to the data points using k-nearest neighbor data, wherein k number of nearest neighbors is a configurable number and the additional artificial dimensions to be added to the data points is equal a number of class labels in a classification problem.

20. The computer program product of claim 19, wherein the computer takes into account proximity of the unlabeled data point to each of the k number of nearest neighbors when re-dimensioning the unlabeled data point.
